(19) United States
(12) Patent Application Publication
(10) Pub. No.: US 2013/0275855 A1
(43) Pub. Date: Oct. 17, 2013

(54) ELECTRONIC DEVICE AND METHOD FOR DISPLAYING SEARCH RESULT

(71) Applicants: CHUNG-I LEE, Tu-Cheng (TW); CHIEN-FA YEH, Tu-Cheng (TW); YUE-CEN LIU, Tu-Cheng (TW); GEN-CHI LU, Tu-Cheng (TW)

(72) Inventors: CHUNG-I LEE, Tu-Cheng (TW); CHIEN-FA YEH, Tu-Cheng (TW); YUE-CEN LIU, Tu-Cheng (TW); GEN-CHI LU, Tu-Cheng (TW)

(21) Appl. No.: 13/666,113

(22) Filed: Nov. 1, 2012

(30) Foreign Application Priority Data
Apr. 11, 2012 (TW) 101112714

(51) Int. Cl. G06F 17/00; G06F 17/30

(52) U.S. Cl. 715/234

(57) ABSTRACT

In a method for displaying search results, a first query word is received from an electronic device. The method obtains a first group of web pages corresponding to the first query word, determines a degree of requirement of each web page in the first group for a user according to browsing records of the web pages in the first group by the user, and marks the degree of requirement of each of the web pages in the first group according to a preset rule.

### BACKGROUND

1. Technical Field

Embodiments of the present disclosure relate to data search technology, and particularly to an electronic device and method for displaying search results using the electronic device.

2. Description of Related Art

Some search engines provide related words to a user in response to receiving a query word input by the user. For example, if the user inputs a query word “Japanese patent system,” the related words of “Japanese patent of utility model” and “Japanese patent of design model” may be prompted to the user. Two methods are used to prompt related words to the user. In a first method, the related words are obtained by expanding the query word according to specified words that have higher frequency occurring in the search results.

In a second method, the related words are obtained using a search result clustering method. However, both the two methods cannot provide a relationship between the search results corresponding to a plurality of query words sequentially input by the user several times, and the search engine cannot prompt the user as to which results are understood (or required) by him/her. Therefore, a more efficient method for displaying search results is desired.

### BRIEF DESCRIPTION OF THE DRAWINGS

FIG. 1 is a block diagram of one embodiment of an electronic device including a search result display system.

FIG. 2 is a schematic diagram of function modules of the search result display system included in the electronic device.

FIG. 3 is a flowchart of one embodiment of a method for displaying searching results using the electronic device.

FIGS. 4-7 are exemplary schematic diagrams of user search interfaces.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other storage medium.

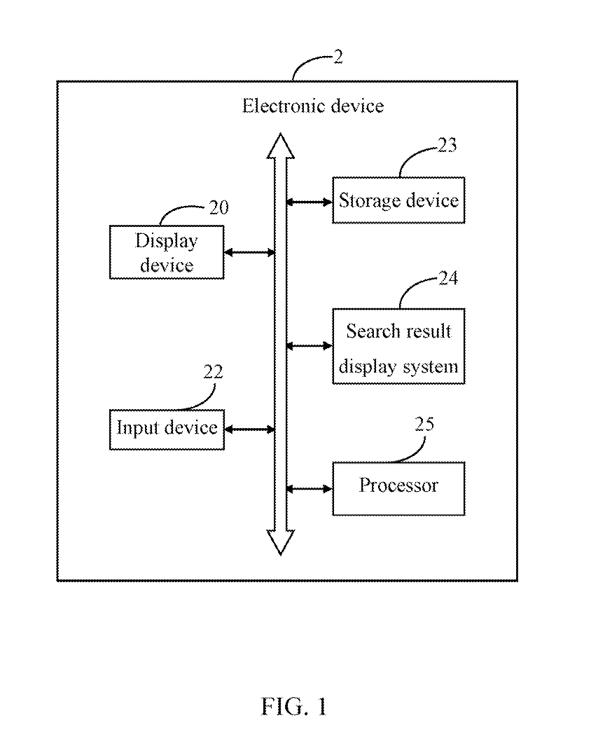

FIG. 1 is a block diagram of one embodiment of an electronic device 2 including a search result display system 24. In the embodiment, the electronic device 2 further includes a display device 20, an input device 22, a storage device 23, and at least one processor 25. The electronic device 2 may be a computer, a smart phone or a personal digital assistant (PDA). It should be understood that FIG. 1 illustrates only one example of the electronic device 2 that may include more or fewer components than illustrated, or have a different configuration of the various components in other embodiments.

The display device 20 may be used to display search results matching with preset query words, and the input device 22 may be a mouse or a keyboard used to input computer readable data. The storage device 23 may be a non-volatile computer storage chip that can be electrically erased and reprogrammed, such as a hard disk or a flash memory card.

The search result display system 24 is used to create relationships of search results (e.g., web pages) corresponding to a plurality of query words sequentially input by a user, and highlight specific search results that the user may understand. In one embodiment, the search result display system 24 may include computerized instructions in the form of one or more programs that are executed by the at least one processor 25 and stored in the storage device 23 (or memory). A detailed description of the search result display system 24 will be given in the following paragraphs.

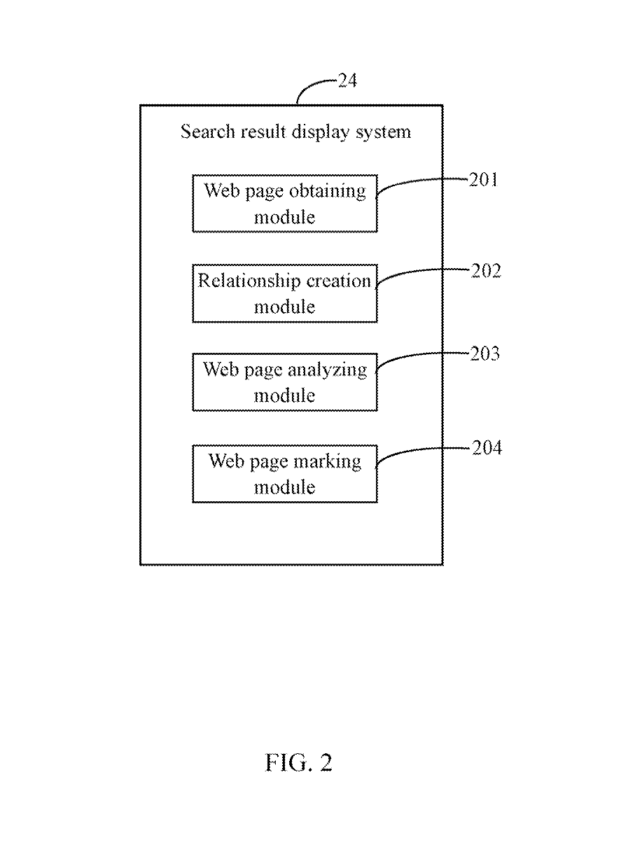

FIG. 2 is a block diagram of function modules of the search result display system 24 included in the electronic device 2. In one embodiment, the search result display system 24 may include one or more modules, for example, a web page obtaining module 201, a relationship creation module 202, a web page analyzing module 203, and a web page marking module 204. In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include flash memory and hard disk drives.

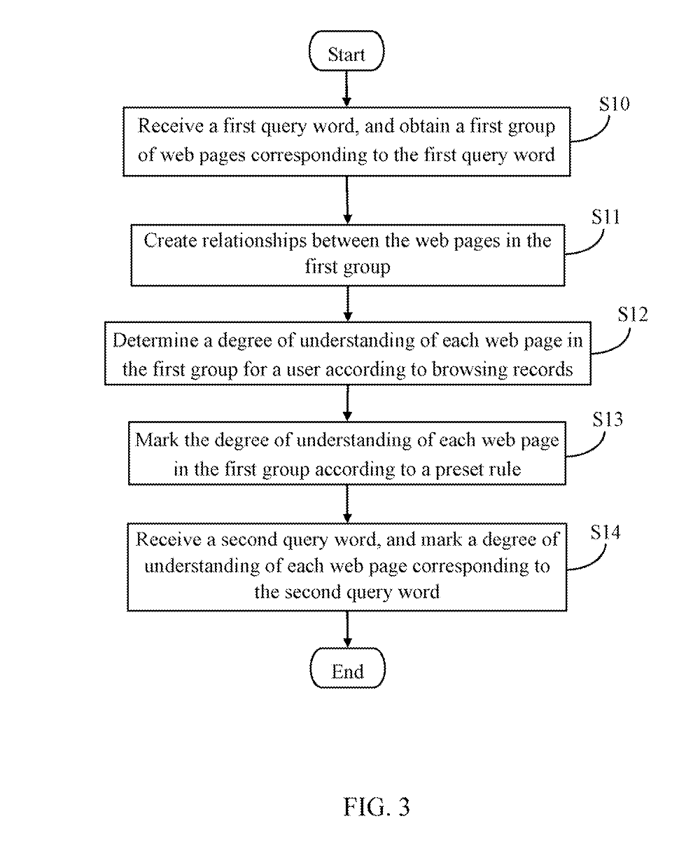

FIG. 3 is a flowchart of one embodiment of a method for displaying search results using the electronic device 2. Depending on the embodiment, additional steps may be added, others removed, and the ordering of the steps may be changed.

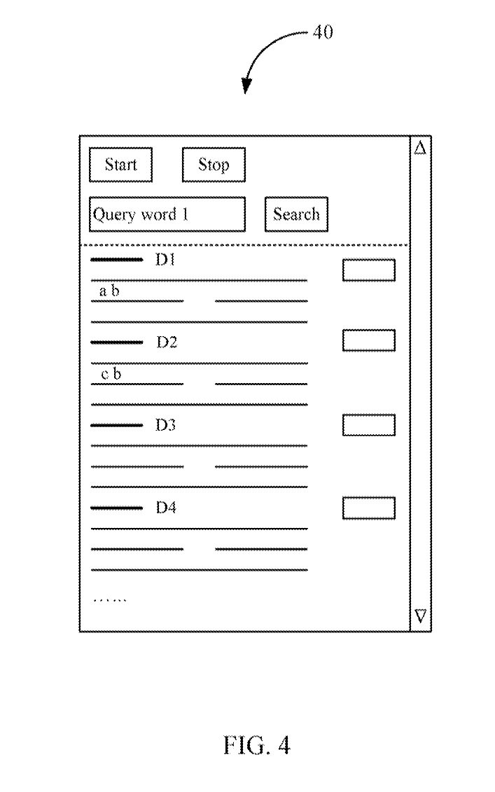

In step S10, the web page obtaining module 201 receives a first query word input by the user, and obtains a first group of web pages corresponding to the first query word. For example, as shown in FIG. 4, when the user inputs the first query word in a user search interface (or user search window) 40, the first group of web pages of “D1”, “D2”, “D3”, and “D4” are displayed in the user search interface 40.

In step S11, the relationship creation module 202 creates relationships between the web pages in the first group. In one embodiment, the relationship creation module 202 creates relationships between the web pages, so that unimportant web pages which are unrelated to the first query word may be removed. For example, if the first query word is “Japanese patent system”, the web page “D1” describes the Japanese patent of utility model, and a web page “D5” describes the earthquake in Japanese, thus, the web page “D5” is removed by the relationship creation module 202. Some relevant descriptions on creating relationships between the web pages can be found in at least followed article, such as the website of http://www.google.com.tw/books?id=6gsdU1y5h5UC&1pg=PA355&ots=C7aMd04PAW &1r&h1=zh-TW&pg=PA364#v=onepage&q&f=false.

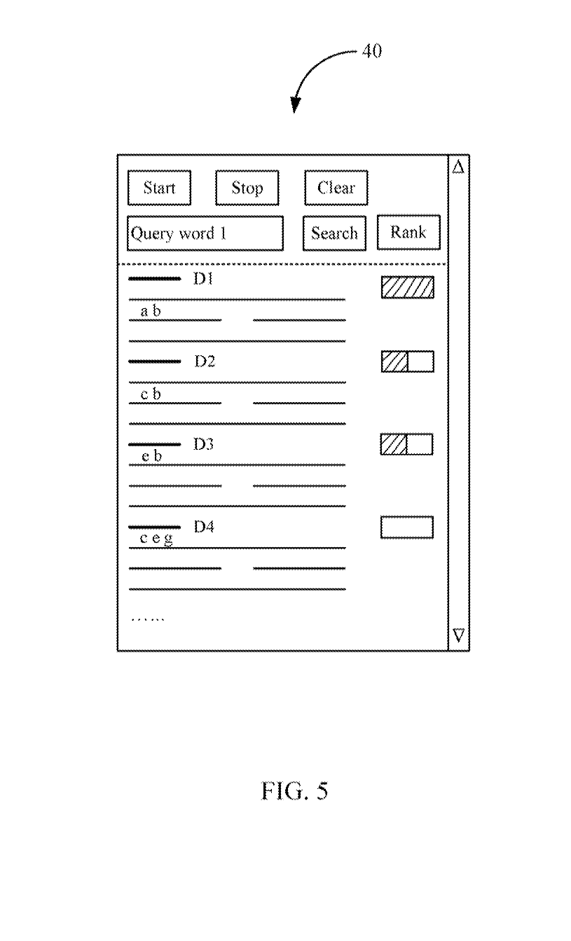

In step S12, the web page analyzing module 203 determines a degree of understanding of each of the web pages (i.e., the relevant web pages created in step S11) in the first group for the user according to browsing records of the web pages in the first group by the user. For example, as shown in FIG. 5, when the user presses a “Start” button in the user search interface 40, step S12 is executed.

In one embodiment, the degree of understanding of a web page is determined as an indicator of words of interest which have been read by the user in all of the words of interest in the web page. In one embodiment, the indicator may be a ration of words of interest which have been read by the user in all of the words of interest in the web page. The words of interest may be nouns in the web page, or specified terms having higher occurrence frequency in the web page, such as the first three terms having high occurrence frequency. For example, as shown in FIG. 5, the web page “D2” includes two words of interest, such as “c” and “b”, where the word of interest “b” has been read by the user in the web page “D1”, thus, the degree of understanding of the web page “D2” is determined as 1/2=50%.

In step S13, the web page marking module 204 marks the degree of understanding of each web page in the first group according to a preset rule. In one embodiment, the preset rule may be a method of marking the degree of understanding for each web page using a progress bar or a highlight mode, such as a specified color (e.g., red) or a specified font (e.g., bold).

For example, as shown in FIG. 5, the web page “D1” includes two words of interest, such as “a” and “b”, the web page “D2” includes two words of interest, such as “c” and “b”, the web page “D3” includes two words of interest, such as “e” and “b”, and the web page “D4” includes three words of interest, such as “c”, “e”, and “g”.

Suppose that the web page “D1” has been read by the user, the web page analyzing module 203 determines that the web page “D2” and “D3” include the word of interest of “b” which has been read by the user. Thus, the web page “D2” and “D3” are determined as web pages which may be understood (or required) by the user, the degree of the understanding is determined as 1/2=50%. Because the web page “D4” does not include any word of interest which has been read by the user, thus, the web page “D4” is determined as a web page which is not understood (or not required) by the user, the degree of the understanding is determined as zero.

Further, the web page marking module 204 marks the degree of the understanding of the web page “D1” as 100% (i.e., a full progress bar), marks the degree of the understanding of the web pages “D2” and “D3” as 50% (i.e., a half progress bar), and marks the degree of the understanding of the web page “D4” as zero (i.e., an empty progress bar). In one embodiment, when the ration of the web page is larger, the web page has higher understanding to the user. That is, the web page is, or is closer to, what the user most expects to view or access.

The user may press or click the “Stop” button in the user search interface 40 to stop marking the degree of understanding of the web pages, or click the “Clear” button to withdraw the marked information, such as the progress bar, the specified color, and the specified font. The “Rank” button is used to invoke a function of arranging the web pages in the first group according to the degree of understanding of each web page.

In step S14, if a second query word is input by the user on the user search interface 40, the web page marking module 204 marks a degree of understanding (or requirement) of each web page in a second group corresponding to the second query word according to browsing records of the web pages in the first group by the user. A detailed description is as follows.

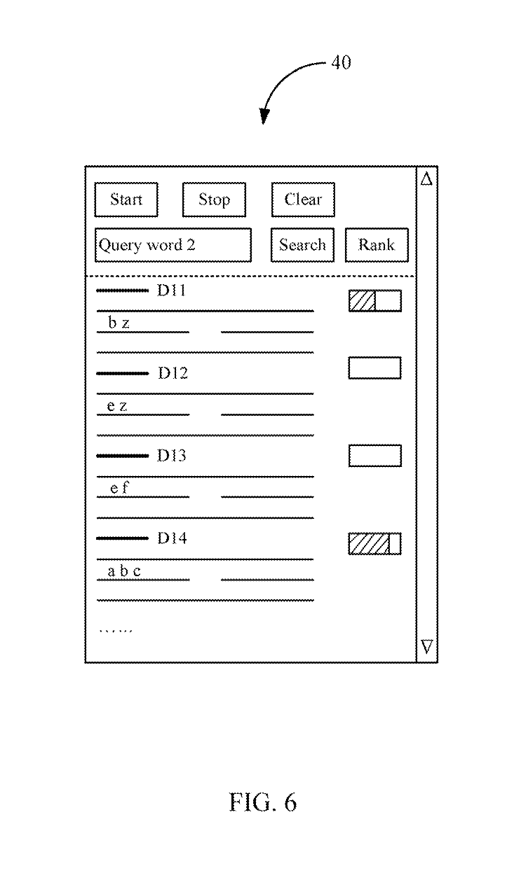

The web page obtaining module 201 receives a second query word input by the user on the user search interface 40, and obtains a second group of web pages corresponding to the second query word. For example, as shown in FIG. 6, when the user inputs the second query word in the user search interface 40, the second group of web pages of “D11”, “D12”, “D13”, and “D14” are displayed on the user search interface 40.

The relationship creation module 202 creates relationships between the web pages in the second group. The web page analyzing module 203 determines a degree of understanding of each of the web pages in the second group for the user according to the browsed web pages (e.g., “D1”) in the first group by the user. Then, the web page marking module 204 marks the degree of understanding of each web page in the second group according to the preset rule.

For example, as shown in FIG. 6, the web page “D11” includes two words of interest, such as “b” and “z”, the web page “D12” includes two words of interest, such as “e” and “z”, the web page “D13” includes two words of interest, such as “e” and “f”, and the web page “D14” includes three words of interest, such as “a”, “b”, and “c”.

Suppose that the web page “D1” has been read by the user in the first group of the first query word, when the user inputs the second query word, the second group of web pages are obtained, the web page analyzing module 203 determines that the web page “D11” includes the word of interest of “b” which has been read by the user, and the web page “D14” includes the word of interest of “a” and “b” which have been read by the user.

Thus, the web pages “D11” and “D14” are determined as web pages which may be understood by the user even though the web pages “D11” and “D14” are not read by the user, the degree of the understanding (or requirement) of the web page “D11” is determined as 1/2*100%=50%, and the degree of the understanding of the web page “D14” is determined as 2/3*100%=66.7%. Because the web pages “D12” and “D13” do not include any word of interest which has been read by the user, thus, the web pages “D12” and “D13” are determined as web pages which are not understood by the user, the degree of the understanding is determined as zero.

Further, the web page marking module 204 marks the degree of the understanding of the web page “D11” as 50% (i.e., a half progress bar), marks the degree of the understanding of the web pages “D14” as 66.7% (i.e., two third progress bar), and marks the degree of the understanding of the web pages “D12” and “D13” as zero (i.e., an empty progress bar).

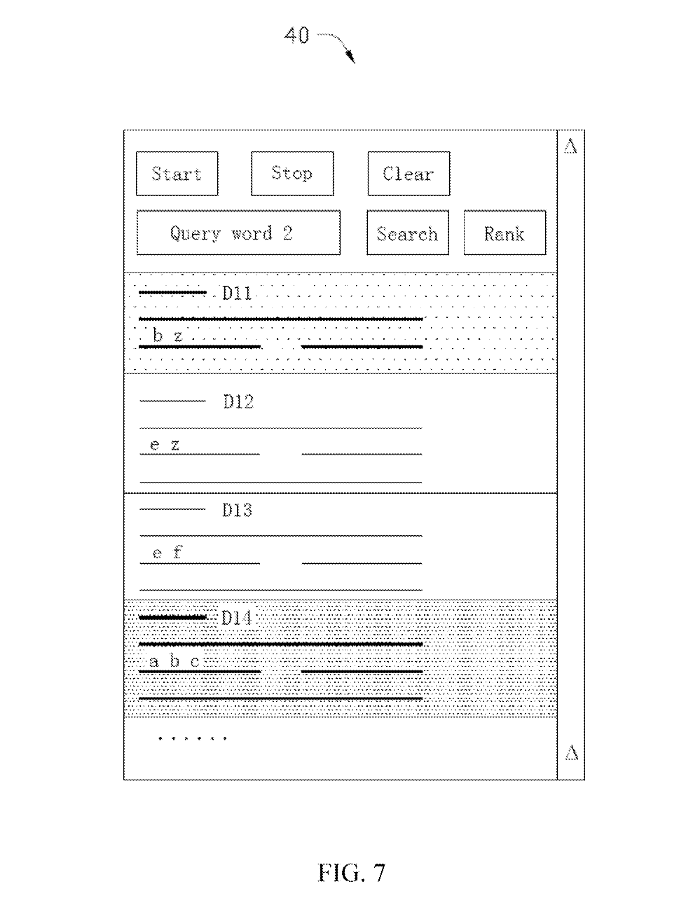

In other embodiments, the web page marking module 204 may mark the web pages “D11” and “D14” in specified colors or specified fonts according to the degree of the understanding of the web page. For example, as shown in FIG. 7, the web page “D14” may be displayed in a deep red color, and the web page “D11” may be displayed in a pink color. The web pages “D12” and “D13” are kept normal.

In the present application, when the user inputs the second query word, event though the user does not read the searched web pages corresponding to the second query word, the web pages which may be understood by the user are marked according to the browsing record of previous web pages (e.g., the web pages in the first group) by the user. For example, the web pages which may be understood by the user are displayed in specified colors or fonts, so that the user may directly select the marked web pages to read, or select the un-marked web pages to learn more information.

Furthermore, if a third query word is input by the user on the user search interface 40, the web page marking module 204 marks a degree of understanding (or requirement) for each web page in a third group corresponding to the third query word according to browsing records of the web pages in the first and second groups by the user. The present method may be used to a fourth query word, a fifth query word, for example.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for displaying search results using an electronic device, the method comprising:
receiving a first query word input by a user, and obtaining a first group of web pages corresponding to the first query word;
determining a degree of understanding of each of the web pages in the first group for the user according to browsing records of the web pages in the first group by the user; and
marking the degree of understanding of each of the web pages in the first group according to a preset rule.

2. The method according to claim 1, further comprising:
creating relationships between the web pages in the first group.

3. The method according to claim 1, further comprising:
marking degrees of understanding of each of the web pages in a second group corresponding to a second query word according to browsing records of the web pages in the first group when the second query word is input by the user.

4. The method according to claim 1, further comprising:
receiving a second query word input by the user, and obtaining a second group of web pages corresponding to the second query word;
determining a degree of understanding of each of the web pages in the second group for the user according to browsed web pages in the first group; and
marking the degree of understanding of each of the web pages in the second group according to the preset rule.

5. The method according to claim 1, wherein the preset rule is a method of marking the degree of understanding of each of the web pages using a progress bar or a highlight mode.

6. The method according to claim 1, wherein the degree of understanding of each of the web pages is determined as a ratio of words of interest which have been read by the user in all of the words of interest in each of the web pages.

7. The method according to claim 6, wherein the words of interest are nouns in each of the web pages, or specified terms having higher occurrence frequency in each of the web pages.

8. An electronic device, comprising:
a storage device;
at least one processor; and
one or more modules that are stored in the storage device and are executed by the at least one processor, the one or more modules comprising:
a web page obtaining module that receives a first query word input by a user, and obtains a first group of web pages corresponding to the first query word;
a web page analyzing module that determines a degree of understanding of each of the web pages in the first group for the user according to browsing records of the web pages in the first group by the user; and
a web page marking module that marks the degree of understanding of each of the web pages in the first group according to a preset rule.

9. The electronic device according to claim 8, wherein the one or more modules further comprise:
a relationship creation module that creates relationships between the web pages in the first group.

10. The electronic device according to claim 8, wherein the web page marking module further marks degrees of understanding of each of the web pages in a second group corresponding to a second query word according to browsing records of the web pages in the first group when the second query word is input by the user.

11. The electronic device according to claim 8, wherein:
the web page obtaining module further receives a second query word input by the user, and obtains a second group of web pages corresponding to the second query word;
the web page analyzing module further determines a degree of understanding of each of the web pages in the second group for the user according to browsed web pages in the first group; and
the web page marking module further marks the degree of understanding of each of the web pages in the second group according to the preset rule.

12. The electronic device according to claim 8, wherein the preset rule is a method of marking the degree of understanding of each of the web pages using a progress bar or a highlight mode.

13. The electronic device according to claim 8, wherein the degree of understanding of each of the web pages is determined as a ratio of words of interest which have been read by the user in all of the words of interest in each of the web pages.

14. The electronic device according to claim 13, wherein the words of interest are nouns in each of the web pages, or specified terms having higher occurrence frequency in each of the web pages.

15. A non-transitory storage medium having stored thereon instructions that, when executed by a processor of an electronic device, causes the electronic device to perform a method for displaying search results, the method comprising:
receiving a first query word input by a user, and obtaining a first group of web pages corresponding to the first query word;
determining a degree of understanding of each of the web pages in the first group for the user according to browsing records of the web pages in the first group by the user; and
marking the degree of understanding of each of the web pages in the first group according to a preset rule.

16. The non-transitory storage medium according to claim 15, wherein the method further comprises:
creating relationships between the web pages in the first group.

17. The non-transitory storage medium according to claim 15, wherein the method further comprises:
marking degrees of understanding of each of the web pages in a second group corresponding to a second query word according to browsing records of the web pages in the first group when the second query word is input by the user.

18. The non-transitory storage medium according to claim 15, wherein the method further comprises:
receiving a second query word input by the user, and obtaining a second group of web pages corresponding to the second query word;
determining a degree of understanding of each of the web pages in the second group for the user according to browsed web pages in the first group; and
marking the degree of understanding of each of the web pages in the second group according to the preset rule.

19. The non-transitory storage medium according to claim 15, wherein the preset rule is a method of marking the degree of understanding of each of the web pages using a progress bar or a highlight mode.

20. The non-transitory storage medium according to claim 15, wherein the degree of understanding of each of the web pages is determined as a ratio of words of interest which have been read by the user in all of the words of interest in each of the web pages.
